(19) United States
(12) Patent Application Publication
(10) Pub. No.: US 2020/0349483 A1
(43) Pub. Date: Nov. 5, 2020

(54) RISK HIERARCHY AND ROLL-UP SCORING

(71) Applicant: ServiceNow, Inc., Santa Clara, CA (US)

(72) Inventors: Anushree Shrivallabh Randad, Santa Clara, CA (US); Maurice Olivier Marin, San Diego, CA (US); Santosh Srinivas Vaddadi, Hyderabad (IN); Ayush Aggarwal, Hyderabad (IN); Jorge Daniel Garcia, Waltham, MA (US); Pooja Kotagiri, Hyderabad (IN); Utkarsh Jain, Hyderabad (IN); Naveen Kumar Pokala, Hyderabad (IN)

(21) Appl. No.: 16/548,468

(22) Filed: Aug. 22, 2019

Related U.S. Application Data
(60) Provisional application No. 62/842,894, filed on May 3, 2019.

(51) Int. Cl. G06Q 10/06; G06Q 40/00

(52) U.S. Cl. CPC G06Q 10/0635; G06Q 40/125; G06Q 10/067

(57) ABSTRACT

The present approach provides a framework and tool for assessing and managing risk at the level of an organization or enterprise or with respect to sub-entities of such an organization or enterprise. In accordance with this approach a user may assess risk at various organizational levels and in accordance with various configurable parameters.

### CROSS-REFERENCE TO RELATED APPLICATION

This application claims priority to and the benefit of U.S. Provisional Application No. 62/842,894, entitled “RISK HIERARCHY AND ROLL-UP SCORING”, filed May 3, 2019, which is herein incorporated by reference in its entirety.

### BACKGROUND

The present disclosure relates generally to risk management and risk assessment.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, are subject to various types of risks, such as risks related to information technology or equipment failures, risks related to policy or training failures, risks related to economic events, risks related to criminal behavior, including cybersecurity, and so forth. Such risks may be difficult to assess or manage at different levels of the organization due to different organizational levels and/or different units within the organization not having the same insight into different risks. Further assessments of risks at different levels of the organization and/or by different units may be difficult to compare due to subjective biases, inconsistent application of metrics, and so forth. As a result, risk management and/or assessment at the organizational level may be difficult to implement. Correspondingly, managing the various risks that may be present for an enterprise or organization may also be difficult.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present approach provides a framework and tool for monitoring the kinds of risk to which an organization or enterprise is exposed, the extent of the risks, the monetary impact or implications of such risks, and/or ways to mitigate or remediate such risks. In certain functionalities, the present approach allows for establishing a hierarchy and/or aggregation of risk at the organizational level or a sub-level and for assessment or management of risks at the organizational level or sub-level.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a block diagram of a computing device utilized in a computing system that may be present in FIG. 1, in accordance with aspects of the present disclosure;

FIG. 3 is a block diagram illustrating an embodiment in which a virtual server supports and enables the client instance, in accordance with aspects of the present disclosure;

FIG. 4 depicts a profile hierarchy, in accordance with aspects of the present disclosure;

FIG. 5 depicts a pair of risk hierarchies, in accordance with aspects of the present disclosure;

FIG. 6 depicts an example of a screen on which risk rollup and tolerance can be viewed, in accordance with aspects of the present disclosure;

FIG. 7 depicts an example of risk rollup, in accordance with aspects of the present disclosure;

FIG. 8 depicts an example of a report on which rollup risk information can be viewed and compared for different profiles, in accordance with aspects of the present disclosure;

FIG. 9 depicts an example of a dashboard on which profile tolerance statuses are displayed, in accordance with aspects of the present disclosure;

FIG. 10 depicts an example of a dashboard on which aggregated profile risk information is displayed, in accordance with aspects of the present disclosure; and

FIG. 11 depicts an example of a dashboard on which aggregated risk information is displayed, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In the context of the present risk management approach, a “profile” or “entity” may represent a discrete unit for which a user may want to evaluate, assess, or manage risk. Such “profiles” may have a hierarchical relationship amongst themselves that can be modeled as upstream and downstream relationships, and which may be characterized herein as a “profile hierarchy”. By way of example, a Security unit profile may have ACME Company (i.e., the parent company) as its upstream profile and Security Unit Engineering Department (i.e., a subset of the Security unit) as a downstream profile. A “risk statement” is a representation of a risk an organization or enterprise want to monitor (e.g., risk of data loss, risk of corruption, and so forth). In isolation, a risk statement has no measurable values. However, as used herein a risk statement can be associated with multiple profiles. When a risk statement is associated with one or more profiles, instances of the risk statement for the profiles may be generated to yield “risks” or “risk instances” that have a score or other metric quantifying the risk if the risk where to be realized for the associated profile (e.g., potential monetary loss that the enterprise will face if the risk is realized for the associated profile). As with profiles, risk statements can also be seen as having a hierarchical relationship and, further, an organization may have multiple risk statement hierarchies (e.g., a different risk statement hierarchy for each geographical location where the organization operates).

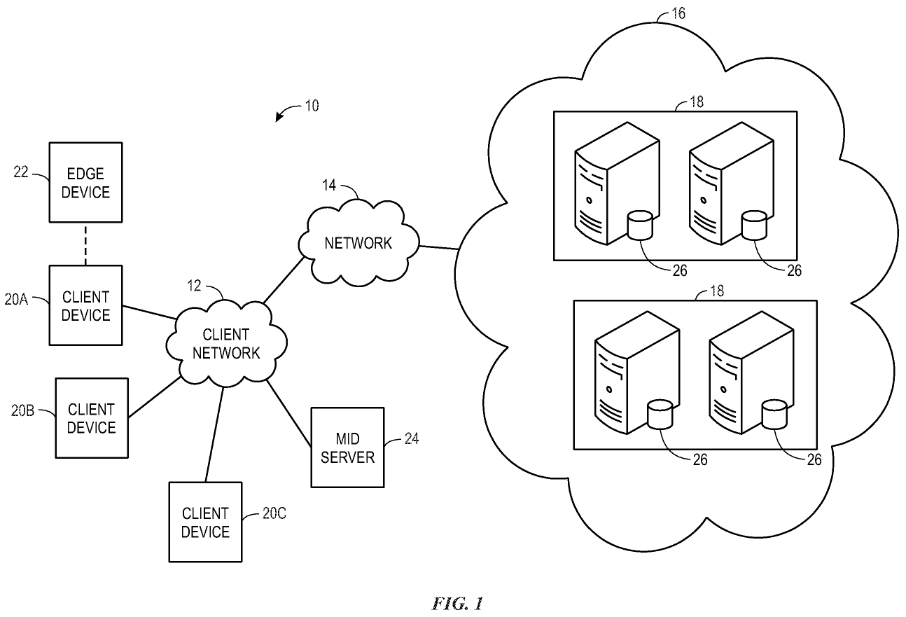

Example of measures or scores that may be part of a risk or risk instance include, but are not limited to: “single loss expectancy” (SLE) (corresponding to the monetary value expected from the occurrence of a risk on a profile. For example, SLE of an accident to a car can be the cost of its repairs); “annual rate of occurrence” (ARO) (corresponding to the probability that a risk will occur in a particular year, which may depend on many factors. For example, the probability a car will be involved in an accident in a given year); “annual loss expectancy” (ALE) (corresponding to be expected monetary loss that can be expected for a profile due to a risk over a one year period, which may be defined as: ALE=SLE*ARO); and “calculated ALE” or “risk score” (corresponding to the ALE calculated for each risk). With the preceding background and concepts in mind, the following figures relate to various types of generalized system architectures or configurations that may be employed to provide services to an organization in a multi-instance framework and on which the present approaches may be employed, though they may be applied, more generally, on any processor-based system capable of accessing and/or processing the data structures described herein. Correspondingly, these system and platform examples may also relate to any and all systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules.

Although FIG. 1 illustrates a specific embodiments of a cloud computing system 10, the disclosure is not limited to the specific embodiments illustrated in FIG. 1. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, virtual servers 26A, 26 and virtual database servers may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIG. 1 is only to provide an example to facilitate ease of description and explanation and is not intended to limit the disclosure to the specific examples illustrated therein.

As may be appreciated, the respective architecture and framework discussed with respect to FIG. 1 incorporates computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

By way of background, it may be appreciated that the present approach may be implemented using one or more processor-based systems such as shown in FIG. 2. Likewise, applications and/or databases utilized in the present approach may be stored, employed, and/or maintained on such processor-based systems. As may be appreciated, such systems as shown in FIG. 2 may be present in a distributed computing environment, a networked environment, or other multi-computer platform or architecture. Likewise, systems such as that shown in FIG. 2, may be used in supporting or communicating with one or more virtual environments or computational instances on which the present approach may be implemented.

With this in mind, an example computer system may include some or all of the computer components depicted in FIG. 2. FIG. 2 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206. With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

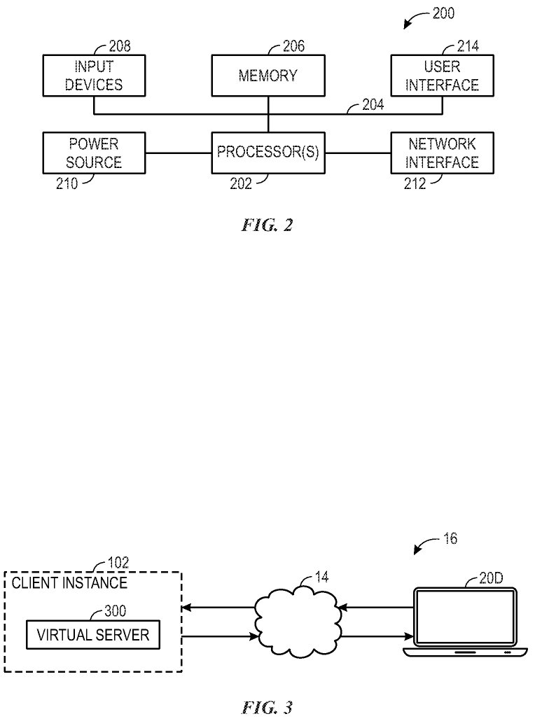

By way of further example, FIG. 3 is a block diagram illustrating an embodiment in which a virtual server 300 supports and enables the client instance 102, according to one or more disclosed embodiments. More specifically, FIG. 3 illustrates an example of a portion of a service provider cloud infrastructure, including the cloud-based platform 16 discussed above. The cloud-based platform 16 is connected to a client device 20D via the network 14 to provide a user interface to network applications executing within the client instance 102 (e.g., via a web browser of the client device 20D). Client instance 102 is supported by virtual servers 26, and is illustrated here to show support for the disclosed functionality described herein within the client instance 102. Cloud provider infrastructures are generally configured to support a plurality of end-user devices, such as client device 20D, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

With the preceding in mind, a risk management application as described herein may be implemented and used using such a client instance based architecture, as described above, but as also noted above, may be implemented in other networked environments or on stand-alone computers as well.

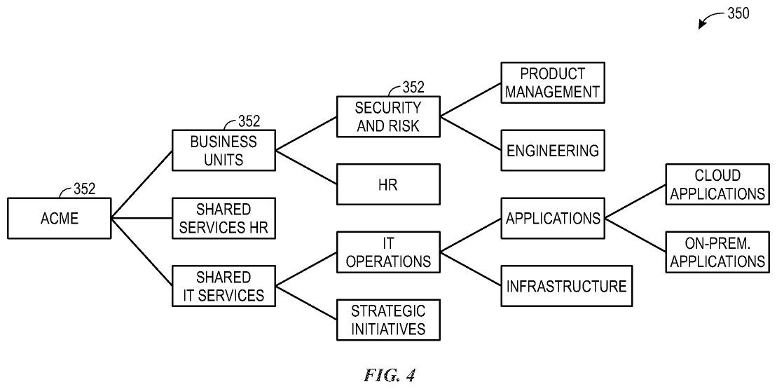

With respect to the present risk management techniques, the following discussion relates to aspects of the present risk management approach, including examples of implementations in the context of a risk management application. Turning to FIG. 4, an example of a profile hierarchy 350 is depicted in which different profiles or entities 352 within an organization are arranged hierarchically from the highest level (leftmost) to lower levels (proceeding rightward in the figure). In the depicted example, the highest level profile encompasses the organization or enterprise (e.g., Acme). By way of example, along one branch, the next level profile corresponds to “Business Units”, which has underneath “Security and Risk” and “Human Resources (HR)”. “Security and Risk” similarly encompasses “Product Management” and “Engineering”.

In one implementation of a risk management application, a given user or organization may design or customize a respective profile hierarchy 350 as shown in FIG. 4 in a manner or order suitable for managing risk for profiles of interest to the user. In one such implementation, flexibility may be provided to allow profiles to be hierarchically ordered based upon functional structure, organizational or divisional structure, a matrix structure, and so forth. Thus different individuals within an organization may construct or modify different hierarchical structures based upon their respective risk assessment or management needs.

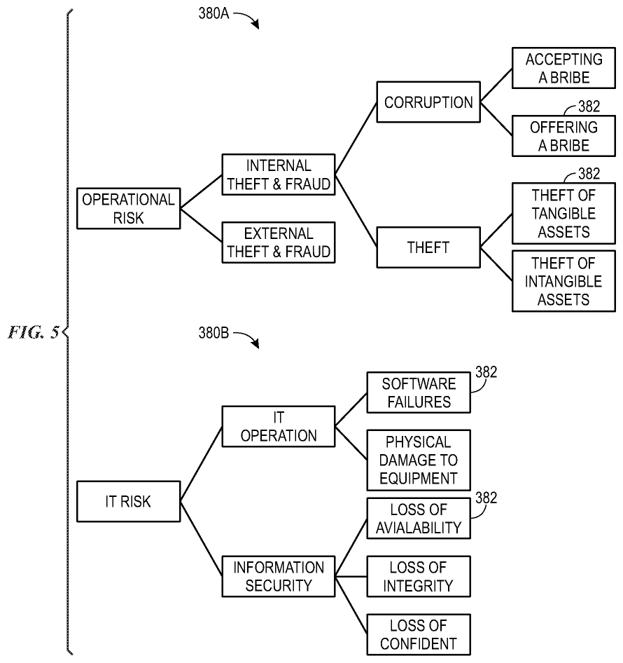

Turning to FIG. 5, in this example a user may also setup one or more risk hierarchies 380, such as the depicted operational risk hierarchy 380A (top tree) and the depicted information technology (IT) risk hierarchy 380B (bottom tree). As in the preceding example, a user may be provided with flexibility in defining or creating the hierarchy of risks. By way of example, the operational risk tree depicted includes sub-categories for “internal theft and fraud” and “external theft and fraud”, which may in turn be broken down through succeeding hierarchies to provide greater risk granularity, down to individual types of corruption or theft (e.g., accepting a bribe, offering a bribe, theft of tangible assets, theft of intangible assets, and so forth). Similarly, the IT Risk tree depicted includes sub-categories for “IT operations” risk and “information security” risk, each of which may also be broken down through succeeding hierarchies to provide greater risk granularity (e.g., software failures, physical damage to equipment, loss of availability, loss of integrity, loss of confidentiality, and so forth).

As may be appreciated, a risk hierarchy 380 as described herein is distinct from downstream and/or upstream risk statements, as there is no causation from the defined relationships. Instead, each node may considered as a class or type of risk. For example, “loss of availability” is a type of “information security” risk in the depicted hierarchy, but there is not a causal relationship in either direction. In accordance with one embodiment, a risk assessment based on a given risk hierarchy 380 established by a user may be performed at the lowest level of the hierarchy (block 382). However, the functionality to assess risk at a higher level may be provided as well. As noted above, risk assessments aren't performed based on a risk statement alone, but instead are performed for a risk or risk instance (i.e., a risk statement in conjunction with a profile).

In accordance with the present approach, and user may define various measures of risk acceptability, such as may be bound by an accepted risk and a maximum acceptable risk for a given profile or profiles and based upon an associated risk hierarchy 380. For example, a user may specify a threshold for risk management purposes for: (1) expected ALE (i.e., the limit within which the profile's owner is most comfortable, generally referred to as “risk appetite”); and/or (2) maximum acceptable ALE (i.e., the limit which the profile owner can still tolerate, generally referred to as “risk tolerance”). For the purpose of the present discussion, the expected ALE and the maximum acceptable ALE may be considered as the lower and upper boundaries of acceptable risk.

For example, in one embodiment, the expected ALE and the maximum acceptable ALE may both be compared to a calculated ALE for a given risk assessment. A visual indicator (e.g., color coding, bolded text, and so forth) may then be used to convey information about the comparison. For example, if the calculated ALE is less than the expected ALE, this may be deemed an acceptable level of risk and this may be indicated visually (e.g., a green color coded result). Conversely, if the calculated ALE is greater than the expected ALE and less than the maximum acceptable ALE, this may be deemed an unacceptable level of risk and visually indicated accordingly (e.g., an amber color coded result). Lastly, if the calculated ALE is greater than the maximum acceptable ALE, this may be deemed a highly unacceptable level of risk and visually indicated accordingly (e.g., a red color coded result). In addition to or instead of such visual coding, a notification or alert may instead be generated in these circumstances to a profile owner or other user when risk thresholds are exceeded.

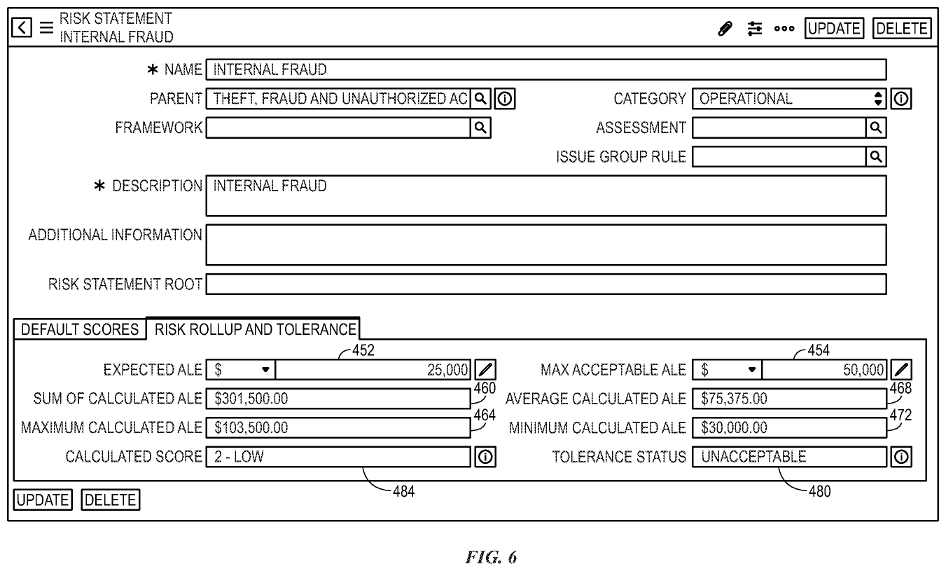

With the preceding discussion regarding profiles and profile hierarchies, risk hierarchies, and risk thresholds, in mind, examples of an application implementation are provided in the form of sample screens, dashboards and reports. For example, FIG. 6 depicts an example of a screen (e.g., a graphical user interface) that may be used by a user to specify risk thresholds for a given risk (here, internal fraud) and to view a current tolerance status for that risk. In particular, in this illustration, a user may specify or select an expected ALE (field 452) and a maximum acceptable ALE (field 454) for the respective risk.

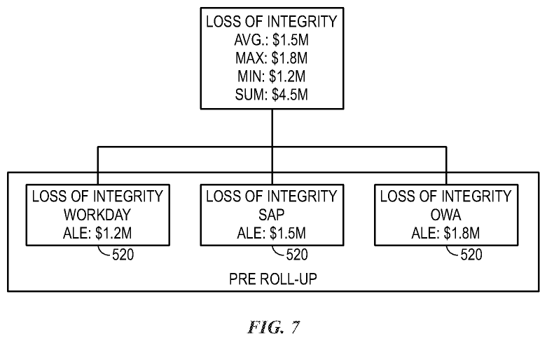

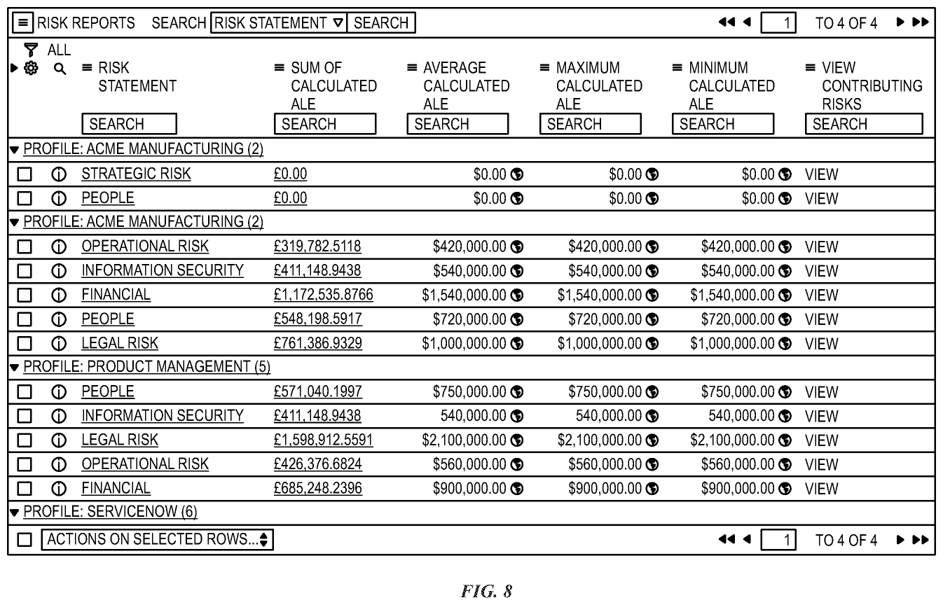

Prior to discussing other aspects of the example screen shown in FIG. 6, the concept of rollup of risk will be briefly described. Turning to FIG. 7, an example of a risk, here “Loss of Integrity” is illustrated at a given hierarchical level, such as for a given profile having sub-profiles. In this example, the risk of “Loss of Integrity” at the hierarchy level in question is determined by the risk of “Loss of Integrity” for a downstream set of profiles (here APP 1, APP 2, and APP 3). Thus, the risk of “Loss of Integrity” that is of interest for the hierarchy level in question is a function of the different possible ways in which downstream profiles manifest the risk of “Loss of Integrity”. With this in mind, in assessing the risk of “Loss of Integrity” at the hierarchy level in question, the underlying risks of the downstream levels in the hierarchy (here APP 1, APP 2, and APP 3) may be combined or aggregated in various ways to reflect different loss or risk scenarios. Turning to the example of FIG. 7, at the hierarchy level of interest the underlying risks (here in the form of an ALE) may be “rolled up” as an average, a sum, a maximum (i.e., the largest of the individual underlying ALEs in the downstream profiles), or a minimum (i.e., the smallest of the individual underlying ALEs in the downstream profiles).

With this in mind, and turning back to FIG. 6, in one implementation of a risk management application, these rollup risk values are automatically calculated based on the associated risk hierarchy for the risk in question and, in one implementation, are displayed (i.e., sum of calculated ALE field 460, maximum calculated ALE field 464, average calculated ALE field 468, and minimum calculated ALE field 472). Using one or more of these rollup values, a risk tolerance status (field 480) may be automatically calculated and displayed for a selected one of the rollup metrics (e.g., average calculated ALE) based on a comparison of this value and the defined expected ALE (field 452) and maximum acceptable ALE (field 454). In the depicted example a visual indicator (e.g., a color code) is provided with the risk tolerance status. Similarly, a calculated risk score (field 484) may be calculated and displayed conveying a measure of the risk based on a comparison of the selected rollup metric and risk tolerance established by the thresholds. Though the present example is in the context of a risk statement, the corresponding analysis or view may also be performed for a profile of interest.

With respect to generating and updating risk tolerance status and/or risk scores, such metrics may be of value to various types of stakeholders in an organization. By way of example, risk managers and/or risk executives (e.g., members of a central risk management team) may use such risk tolerance status or risk scores for determining the most significant (e.g., top ten) risks at the enterprise or organizational level based on highest loss expectancy (ALE) and what is driving such risks (e.g., geographic considerations, data security, potential illegal activity, and so forth). Similarly, such risk managers may use such risk tolerance status or aggregated risk scores for determining what departments or units are at the highest risk and what their expected loss expectancy is. In addition, entity managers (e.g., individuals who have profit and loss (P&L) responsibility for their respective entity or profile) may use such measures for determining the most significant (e.g., top ten) risks at the level of their entity or profile and what is driving these risks. Similarly, an entity manager may use such measures to determine what sub-entities of their entity are at high risk and their respective ALE. Thus, as may be appreciated, risk reporting and assessment in accordance with these approaches may be customized as to the level and/or degree to which risk is aggregated or rolled up based on the use and user so as to allow risk assessment and management at both the organizational and department or unit level. With this in mind, risk reports may be automatically generated or modified (such as using the steps and processes described herein) that provide different views relevant to the user or use. Examples of such views and their uses may include: (1) an aggregated risk view that provides an overall score of the risk irrespective of the entity; (2) an aggregated entity view that provides an overall score of the entity irrespective of the risk; and (3) an entity versus risk view that provides a risk score for that entity or group of entities.

An example of one report that may be generated and viewed is provided in FIG. 8. In this example, a user may view and select from a listing of profiles, which may be displayed according to the associated profile hierarchy. For each profile, rollup risk measures (e.g., sum of calculated ALE, average calculated ALE, maximum calculated ALE, minimum calculated ALE, and so forth) are displayed. In this manner, a reviewer may navigate through the profiles and see for a given profile or group of profiles, the relative risk based on a suitable rollup measure of risk. In addition, a reviewer may select, as shown in the rightmost column, to view contributing sources of risk for a given profile.

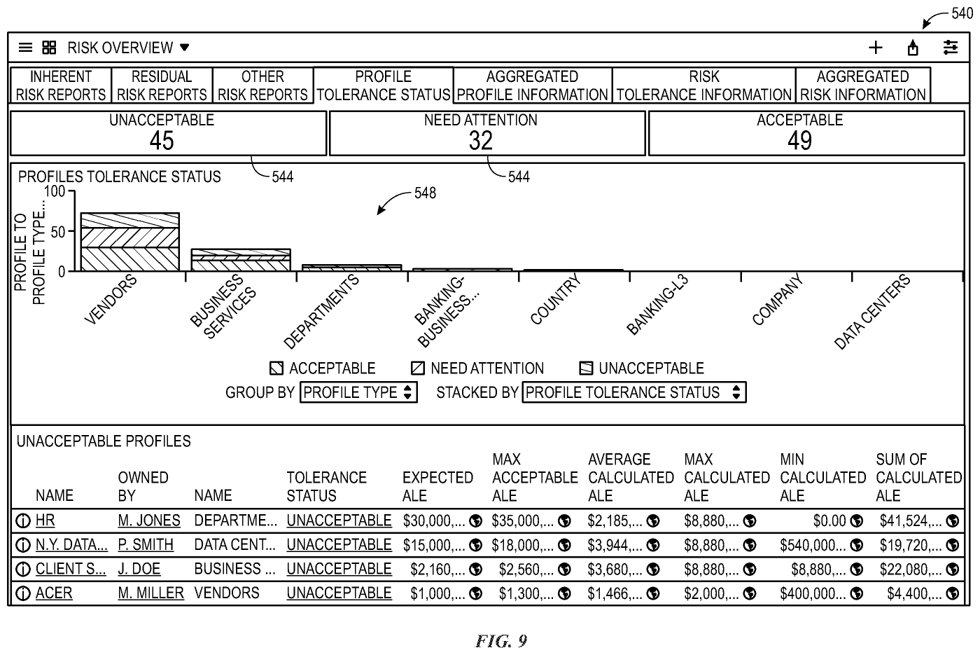

Turning to FIGS. 9-11, additional views that may be provided to a reviewer are illustrated. In these examples, the relevant views are provided as dashboards 540 on which one or more widgets 544, graphics or charts 548, and or reports or listings 552 are displayed that convey risk information as described above (e.g., risk scores, tolerance status, and so forth). Such information may be displayed for a given level of a profile or risk hierarchy and may thereby encompass downstream risk metrics as well for the selected level.

By way of example, FIG. 9 depicts a profile tolerance status dashboard in which widgets 544 display a count of current profiles having tolerance statuses that are unacceptable, acceptable, or need attention. In addition, a graphic 548 is a chart broken down by profile that illustrates this information graphically. A listing 552 lists unacceptable profiles for further review.

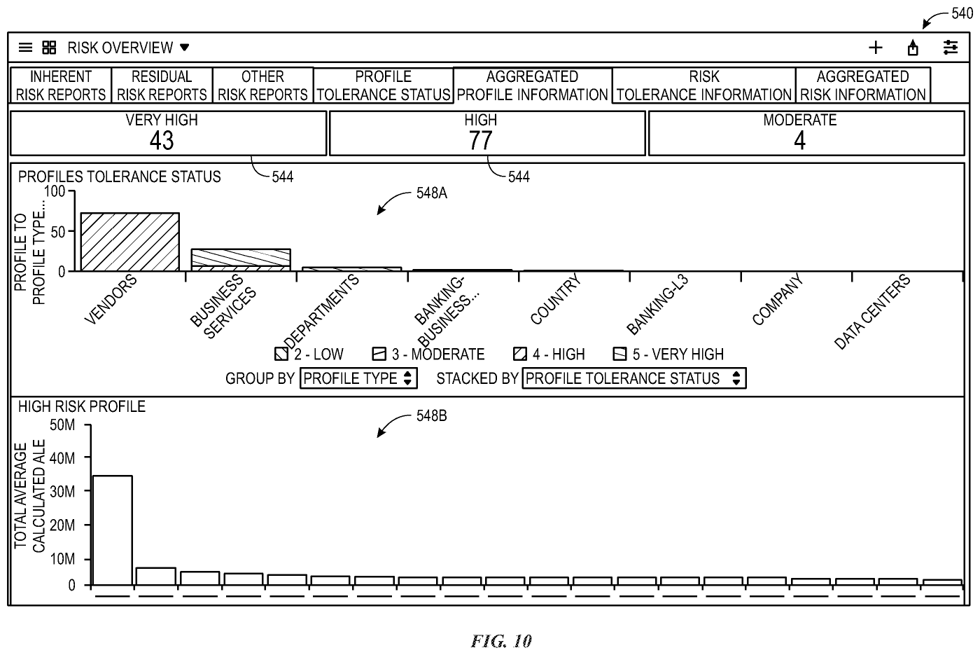

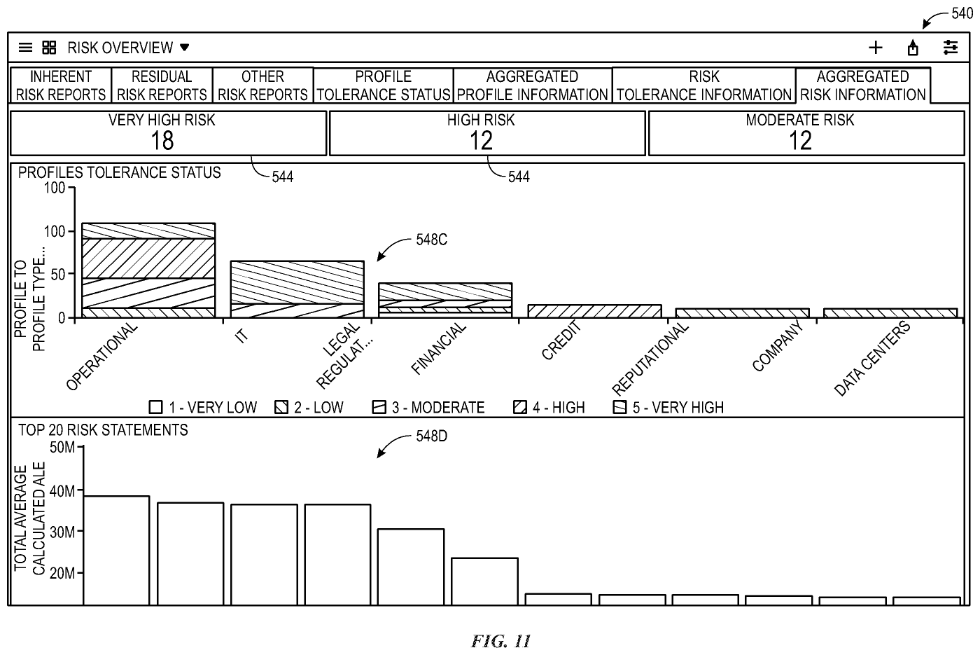

In the example of FIG. 10, an aggregated profile information dashboard is depicted. In this example, widgets 544 are displayed that provide a count of current profiles having risk ratings that are very high, high, or moderate. In addition, a first graphic 548A is a chart broken down by profile that illustrates this risk rating information graphically. A second graphic 548B visually provides information regarding high risk profiles based on profile and total average calculated ALE.

In a third dashboard 540 (FIG. 11), an aggregated risk information dashboard is depicted. In this example, widgets 544 are displayed that provide a count of current risk category having ratings that are very high risk, high risk, or moderate risk. In addition, a first graphic 548C is a chart broken down by risk category that illustrates this risk rating information graphically. A second graphic 548B visually provides information regarding risk statements of note based on total average calculated ALE.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A processor-based system, comprising:
a processor configured to execute instructions;
a memory configured to store instructions executable by the processor, wherein the instructions, when executed by the processor, cause the processor to perform acts comprising:
receiving as inputs a lower risk threshold and an upper risk threshold for one or more of an organizational entity or a risk category at a first level of a hierarchy;
calculating one or more aggregated risk measures for the organizational entity or the risk category, wherein the one or more aggregated risk measures are derived from risk measures associated with a plurality of entities or categories at lower levels of the hierarchy;
comparing at least one of the one or more aggregated risk measures to the lower risk threshold and the upper risk threshold; and
based upon the comparison, generating one or both of a risk score or a risk tolerance status for the organizational entity or risk category.

2. The processor-based system of claim 1, wherein the lower risk threshold comprises an expected loss and the upper risk threshold comprises a maximum acceptable loss.

3. The processor-based system of claim 2, wherein the expected loss comprises an expected annual loss expectancy and the maximum acceptable loss comprises a maximum acceptable annual loss expectancy.

4. The processor-based system of claim 1, wherein calculating the one or more aggregated risk measures comprises calculating one or more of a sum of calculated losses, a maximum calculated loss, a minimum calculated loss, or an average of calculated losses for the risk measures associated with a plurality of entities or categories at lower levels of the hierarchy.

5. The processor-based system of claim 4, wherein the sum of calculated losses comprises a sum of calculated annual loss expectancies, the maximum calculated loss comprises a maximum calculated annual loss expectancy, the minimum calculated loss comprises a minimum calculated annual loss expectancy, and the average of calculated losses comprises an average of calculated annual loss expectancies.

6. The processor-based system of claim 1, wherein the risk tolerance status comprises an unacceptable status when the at least one of the one or more aggregated risk measures exceeds the upper risk threshold.

7. The processor-based system of claim 1, wherein the risk tolerance status comprises an acceptable status when the at least one of the one or more aggregated risk measures is less than the lower risk threshold.

8. The processor-based system of claim 1, wherein one or both of the risk score of the risk tolerance status are displayed with a color coding.

9. A method for assessing organizational risk, comprising the acts of:
automatically calculating aggregated risk measures for each of one or more profiles of a profile hierarchy or one or more risk categories of a risk hierarchy;
generating and displaying a report based upon the profile hierarchy or risk hierarchy, wherein each profile of the profile hierarchy or risk category of the risk hierarchy is listed with the respective aggregated risk measures for that profile or risk category.

10. The method of claim 9, further comprising:
displaying a selectable option to display one or more contributing risks for each profile or risk category, wherein the contributing risks comprise data related to those risks used to calculate the aggregated risk measures.

11. The method of claim 9, wherein calculating the one or more aggregated risk measures comprises calculating one or more of a sum of calculated losses, a maximum calculated loss, a minimum calculated loss, or an average of calculated losses for the risk measures associated with a plurality of entities or categories at lower levels of the hierarchy.

12. The method of claim 11, wherein the sum of calculated losses comprises a sum of calculated annual loss expectancies, the maximum calculated loss comprises a maximum calculated annual loss expectancy, the minimum calculated loss comprises a minimum calculated annual loss expectancy, and the average of calculated losses comprises an average of calculated annual loss expectancies.

13. The method of claim 9, wherein the profile hierarchy comprises an organization hierarchy relating one or more entities in an organization or enterprise to one another.

14. A dashboard interface for display on a processor-based system, the dashboard interface comprising:
one or more widget counters indicating a number of entities that have acceptable or unacceptable risk characteristics at a given time.

15. The dashboard interface of claim 14, wherein the entities comprise organizational profiles or risk categories.

16. The dashboard interface of claim 14, further comprising:
one or more charts or graphs depicting a breakdown of entities having acceptable or unacceptable risk characteristics as a function of organizational profile or risk category.

17. The dashboard interface of claim 14, further comprising:
one or more reports or listings conveying information about organizational profiles or risk categories acceptable or unacceptable risk characteristics.

18. The dashboard interface of claim 14, wherein the one or more widget counters indicating the number of entities that have an acceptable or unacceptable risk tolerance status.

19. The dashboard interface of claim 14, wherein the one or more widget counters indicating the number of entities that have an acceptable or unacceptable aggregated risk rating or profile risk rating.
